(19) United States
(12) Patent Application Publication
(10) Pub. No.: US 2023/0228851 A1
(43) Pub. Date: Jul. 20, 2023

(54) EFFICIENT LASER ILLUMINATION FOR SCANNED LIDAR

(71) Applicant: Allegro MicroSystems, LLC, Manchester, NH (US)

(72) Inventors: Andrew S. Huntington, Banks, OR (US); Bryan Cadugan, Bedford, NH (US)

(73) Assignee: Allegro MicroSystems, LLC, Manchester, NH (US)

(21) Appl. No.: 17/566,763

(22) Filed: Dec. 31, 2021

(51) Int. Cl. G01S 7/481; G02B 3/00; G02B 5/18

(52) U.S. Cl. CPC G01S 7/4814; G01S 7/4816; G01S 7/4817; G02B 3/0087; G02B 5/18

(57) ABSTRACT

Lidar transmission optics and systems project more laser pulse energy per pixel instantaneous field-of-view (IFOV) to a portion of a sensor field of view (FOV), e.g., a portion that would be expected to have both close and distant objects of interest, and proportionally less pulse energy per pixel IFOV to other portions of the sensor FOV, e.g., those that would be expected to have or see only close objects of interest. Optics such as diffractive optical elements (DOEs), gradient-index (GRIN) lenses, and/or compound lens systems can be used for producing desired irradiance distributions having multiple parts or regions. The optics and systems improve range performance by providing for more efficient use of the total available laser pulse energy than transmit optics that project uniform pulse energy per pixel IFOV across the sensor FOV.

### BACKGROUND

One type of light detection and ranging (lidar) system relies on the times-of-flight of laser pulses traveling between the system and objects or surfaces at locations remote from the lidar system to determine distances to those objects or surfaces. In operation of such a system, laser pulses are transmitted to and reflected from distant objects and surfaces, with a portion of each reflected pulse returning to the lidar system (“pulse returns”) where they are detected by an optical detector. A timing system determines the times-of-flight of the pulse returns and thus the distances to the distant objects and surfaces based on the speed of light. Lidar is commonly used for surveying areas of interest and can be used, depending on applications, over long distances, e.g., satellite-based lidar used for ground mapping. Lidar has also become more prevalent in automotive applications, e.g., as part of advanced driver assistance systems (ADAS) or autonomous driving (AD) systems.

Lidar systems can use a single laser or multiple lasers to transmit pulses, and single or multiple detectors for sensing and timing the pulse returns. A lidar system’s field-of-regard (FOR) is the portion of a scene that it can sense over multiple observations, whereas its field-of-view (FOV) is the portion of the scene that its detectors can sense in a single observation. Depending on type of lidar system, the FOV of its detectors may be scanned over its FOR over multiple observations (“scanned lidar”), or in a “staring” system the detector FOV may match the FOR, potentially updating the scene image with every observation. However, during a single observation, a lidar system can only sense the parts of its detector FOV that are illuminated by its laser. The area of the scene illuminated by a single laser pulse may be scanned over the detector FOV, necessitating multiple observations to image the part of the scene within that FOV, or it may be matched to the detector FOV (“flash lidar”) and either scanned along with the FOV over a larger FOR, or it may illuminate the entire FOR in a staring flash lidar system. These lidar system architectures differ with respect to how much laser energy per pulse is needed, how fast the laser must pulse, and how rapidly a three-dimensional image of a given FOR can be collected.

In scanned lidar systems, the returns collected by each detector of the sensor (each constituting a point in the FOR) are aggregated over multiple laser shots to build up a “point cloud” in three-dimensional space that maps the topography of the scene. In staring flash lidar systems a complete point cloud is collected with every laser shot. Lidar system architecture with respect to scanning versus staring detectors and scanning versus flash illumination are driven by issues such as the required angular span and resolution of the scene to be imaged, the available power and achievable pulse repetition frequency of the laser, the range over which the lidar system must be effective, and the desired image update rate, among many other factors. Often it is impractical to supply sufficient laser pulse energy per pixel to implement long-range flash lidar in a high-resolution staring system, whereas illuminating too small of a FOV limits the image update rate of high-resolution, wide-FOR scanned lidar systems. Lidar systems that match sensor FOV and laser illumination to the full FOR along one axis of the scene, such as angle-of-elevation, while scanning across the FOR along the other axis, such as azimuthal angle, provide an engineering compromise that limits required laser power while supporting very high image resolution and update rates.

Laser transmit optics used in lidar sensors that scan laser and detector FOV together project a laser spot that overlaps the portion of the scene viewed by the pixels of the sensor array, i.e., the sensor’s field-of-view (FOV). Each pixel of the sensor array views a solid angle within the FOV called its instantaneous field-of-view (IFOV). Most of the lasers used for this type of lidar project a uniform distribution of the laser’s output energy across the sensor’s FOV. However, in systems where the sensor FOV matches the full FOR along at least one axis of the scene, considerable energy is allocated to, and thus wasted on, the IFOVs of pixels towards and at the perimeter of the FOV, which often do not view many distant objects of interest during operation of the lidar.

### SUMMARY

An aspect of the present disclosure is directed to lidar transmit (transmission) or illumination optics, as well as lidar systems having such optics, that project more laser pulse energy per pixel IFOV to a portion of an associated sensor’s FOV, e.g., a portion that would be expected to have both close and distant objects of interest (such as vehicles, pedestrians, and/or stationary objects), and proportionally less pulse energy per pixel IFOV to other portions of the sensor FOV, e.g., those that would be expected to have only close objects of interest. The transmit optics and systems are accordingly able to improve range performance by providing for more efficient use of the total available laser pulse energy than transmit optics that project uniform pulse energy per pixel IFOV across the sensor FOV.

In exemplary embodiments, a laser illumination system for scanned lidar includes a laser operative to produce a laser output; an optic, such as a diffractive optical element (DOE), operative to receive the laser output and produce a fan-beam output having a desired irradiance distribution including (i) a first beam region having an angular spread in a first direction (angle of elevation), and (ii) a second beam region having an angular spread in the first direction (angle of elevation). The angular spread of the first beam region in the first direction can be less than the angular spread of the second beam region in the first direction. The average irradiance within the first beam region can be higher than the average irradiance of the second beam region. The first beam region can be within a solid angle defined by the second beam region. A scanning system is operative to scan the fan-beam output across a desired angular span in a direction substantially orthogonal to the first direction (e.g., in azimuth).

An example lidar transmit (illumination) system includes an optic, such as a diffractive optical element (DOE), gradient-index (GRIN) lens, and/or compound lens system/assembly, that generates an elongated fan-beam with a desired irradiance distribution that is higher in the center portion than at lateral portions. The desired irradiance distribution can provide more laser pulse energy per pixel IFOV to the portion of the sensor FOV that would be expected to contain both close and distant objects of interest under typical operating conditions, while sending proportionally less pulse energy per pixel IFOV to the portions of the sensor FOV that would typically include only close objects of interest under normal operating condition.

In further embodiments of the present disclosure, first and second optics, e.g., DOEs, are used in a lidar transmit system to generate (1) a wide-angle “look-close” fan-beam and (2) a narrow-angle “look-far” fan-beam, depending on which of the optics is selected to receive an output beam from the laser of the system. An actuator and a simple switch, e.g., an optic such as a flip mirror, can be used to change the transmit beam path to select between the optics. Then, in alternating frames, for example, the available laser pulse energy can be spread across either (1) a wide fan of angles of elevation for the purpose of detecting close objects of interest across the full FOV of the sensor, and (2) a narrow fan of angles of elevation for the purpose of detecting close and distant objects within the smaller portion of the FOV that is illuminated. In alternate embodiments, “look-close” and “look-far” illuminations (for range measurements) can be interleaved, e.g., during the azimuthal angle sweep of a single lidar frame, rather than switching configurations between frames.

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The subject technology is susceptible of many embodiments. What follows is illustrative, but not exhaustive, of the scope of the subject technology.

### BRIEF DESCRIPTION OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1 is a block diagram showing major components of an example embodiment of a scanned lidar system, in accordance with the present disclosure.

FIG. 2 is a diagram of an exemplary system utilizing an optic for lidar illumination, in accordance with the present disclosure.

FIG. 3 is a diagram of a lidar illumination system using first and second optics, in accordance with a further embodiment of the present disclosure.

FIG. 4 is a plot showing a comparison of effective range for lidar pulse energy spread across two different angles of angular spread in the vertical direction, in accordance with the present disclosure.

FIG. 5 is a block diagram depicting an example method of designing a diffractive optical element (DOE) having a desired fan-beam profile, in accordance with embodiments of the present disclosure.

FIG. 6 is a schematic diagram of an example computer system that can perform all or at least a portion of methods, algorithms, and processing, in accordance with the present disclosure.

### DETAILED DESCRIPTION

Prior to describing example embodiments of the disclosure some information is provided. Laser ranging systems can include laser radar (ladar), light-detection and ranging (lidar), and rangefinding systems, which are generic terms for the same class of instrument that uses light to measure the distance to objects in a scene. This concept is similar to radar, except optical signals are used instead of radio waves. Similar to radar, a laser ranging and imaging system emits a pulse toward a particular location and measures the return echoes to extract the range.

Laser ranging systems generally work by emitting a laser pulse and recording the time it takes for the laser pulse to travel to a target, reflect, and return to a photoreceiver, which time is commonly referred to as the “time of flight.” The laser ranging instrument records the time of the outgoing pulse-either from a trigger or from calculations that use measurements of the scatter from the outgoing laser light—and then records the time that a laser pulse returns. The difference between these two times is the time of flight to and from the target. Using the speed of light, the round-trip time of the pulses is used to calculate the distance to the target.

Lidar systems may scan the beam (or, successive pulses) across a target area to measure the distance to multiple points across the field of view, producing a full three-dimensional range profile of the surroundings. More advanced flash lidar cameras, for example, contain an array of detector elements, each able to record the time of flight to objects in their field of view.

When using light pulses to create images, the emitted pulse may intercept multiple objects, at different orientations, as the pulse traverses a 3D volume of space. The echoed laser-pulse waveform contains a temporal and amplitude imprint of the scene. By sampling the light echoes, a record of the interactions of the emitted pulse is extracted with the intercepted objects of the scene, allowing an accurate multi-dimensional image to be created. To simplify signal processing and reduce data storage, laser ranging and imaging can be dedicated to discrete-return systems, which record only the time of flight (TOF) of the first, or a few, individual target returns to obtain angle-angle-range images. In a discrete-return system, each recorded return corresponds, in principle, to an individual laser reflection (i.e., an echo from one particular reflecting surface, for example, a tree, pole or building). By recording just a few individual ranges, discrete-return systems simplify signal processing and reduce data storage, but they do so at the expense of lost target and scene reflectivity data. Because laser-pulse energy has significant associated costs and drives system size and weight, recording the TOF and pulse amplitude of more than one laser pulse return per transmitted pulse, to obtain angle-angle-range-intensity images, increases the amount of captured information per unit of pulse energy. All other things equal, capturing the full pulse return waveform offers significant advantages, such that the maximum data is extracted from the investment in average laser power. In full-waveform systems, each backscattered laser pulse received by the system is digitized at a high sampling rate (e.g., 500 MHz to 1.5 GHz). This process generates digitized waveforms (amplitude versus time) that may be processed to achieve higher-fidelity 3D images.

Of the various laser ranging instruments available, those with single-element photoreceivers generally obtain range data along a single range vector, at a fixed pointing angle. This type of instrument—which is, for example, commonly used by golfers and hunters-either obtains the range (R) to one or more targets along a single pointing angle or obtains the range and reflected pulse intensity (I) of one or more objects along a single pointing angle, resulting in the collection of pulse range-intensity data, (R,I)ᵢ, where i indicates the number of pulse returns captured for each outgoing laser pulse.

More generally, laser ranging instruments can collect ranging data over a portion of the solid angles of a sphere, defined by two angular coordinates (e.g., azimuth and elevation), which can be calibrated to three-dimensional (3D) rectilinear cartesian coordinate grids; these systems are generally referred to as 3D lidar and ladar instruments. The terms “lidar” and “ladar” are often used synonymously and, for the purposes of this discussion, the terms “3D lidar,” “scanned lidar,” or “lidar” are used to refer to these systems without loss of generality. Three-dimensional (3D) lidar instruments obtain three-dimensional (e.g., angle, angle, range) data sets. Conceptually, this would be equivalent to using a rangefinder and scanning it across a scene, capturing the range of objects in the scene to create a multi-dimensional image. When only the range is captured from the return laser pulses, these instruments obtain a 3D data set (e.g., angle, angle, range)ₙ, where the index n is used to reflect that a series of range-resolved laser pulse returns can be collected, not just the first reflection.

Some 3D lidar instruments are also capable of collecting the intensity of the reflected pulse returns generated by the objects located at the resolved (angle, angle, range) objects in the scene. When both the range and intensity are recorded, a multi-dimensional data set (e.g., angle, angle, (range-intensity)ₙ) is obtained. This is analogous to a video camera in which, for each instantaneous field of view (FOV), each effective camera pixel captures both the color and intensity of the scene observed through the lens. However, 3D lidar systems, instead capture the range to the object and the reflected pulse intensity.

Lidar systems can include different types of lasers operating at different wavelengths, including those that are not visible (e.g., wavelengths of 840 nm or 905 nm), in the near-infrared (e.g., at wavelengths of 1064 nm or 1550 nm), and in the thermal infrared including wavelengths known as the “eye-safe” spectral region (generally those beyond 1300-nm), where ocular damage is less likely to occur. Lidar transmitters produce emissions (laser outputs) that are generally invisible to the human eye. However, when the wavelength of the laser is close to the range of sensitivity of the human eye—the “visible” spectrum, or roughly 350 nm to 730 nm-the energy of the laser pulse and/or the average power of the laser must be lowered to avoid causing ocular damage . Certain industry standards and/or government regulations define “eye safe” energy density or power levels for laser emissions, including those at which lidar systems typically operate. For example, industry-standard safety regulations IEC 60825-1: 2014 and/or ANSI Z136.1-2014 define maximum power levels for laser emissions to be considered “eye safe” under all conditions of normal operation (i.e., “Class 1”), including for different lidar wavelengths of operation. The power limits for eye safe use vary according to wavelength due to absorption characteristics of the structure of the human eye. For example, because the aqueous humor and lens of the human eye readily absorb energy at 1550 nm, little energy reaches the retina at that wavelength. Comparatively little energy is absorbed, however, by the aqueous humor and lens at 840 nm or 905 nm, meaning that most incident energy at that wavelength reaches and can damage the retina. Thus, a laser operating at, for example, 1550 nm, can—without causing ocular damage—generally have 200 times to 1 million times more laser pulse energy than a laser operating at 840 nm or 905 nm.

One challenge for a lidar system is detecting poorly reflective objects at long distance, which requires transmitting a laser pulse with enough energy that the return signal-reflected from the distant target—is of sufficient magnitude to be detected. To determine the minimum required laser transmission power, several factors must be considered. For instance, the magnitude of the pulse returns scattering from the diffuse objects in a scene is proportional to their range and the intensity of the return pulses generally scales with distance according to 1/R^4 for small objects and 1/R^2 for larger objects; yet, for highly-specularly reflecting objects (i.e., those objects that are not diffusively-scattering objects), the collimated laser beams can be directly reflected back, largely unattenuated. This means that—if the laser pulse is transmitted, then reflected from a target 1 meter away—it is possible that the full energy (J) from the laser pulse will be reflected into the photoreceiver; but—if the laser pulse is transmitted, then reflected from a target 333 meters away—it is possible that the return will have a pulse with energy approximately 10^12 weaker than the transmitted energy. To provide an indication of the magnitude of this scale, the 12 orders of magnitude (10^12) is roughly the equivalent of: the number of inches from the earth to the sun, 10x the number of seconds that have elapsed since Cleopatra was born, or the ratio of the luminous output from a phosphorescent watch dial, one hour in the dark, to the luminous output of the solar disk at noon.

In many cases of lidar systems highly sensitive photoreceivers are used to increase the system sensitivity to reduce the amount of laser pulse energy that is needed to reach poorly reflective targets at the longest distances required, and to maintain eye-safe operation. Some variants of these detectors include those that incorporate photodiodes, and/or offer gain, such as avalanche photodiodes (APDs) or single-photon avalanche detectors (SPADs). These variants can be configured as single-element detectors,-segmented-detectors, linear detector arrays, or area detector arrays. Using highly sensitive detectors such as APDs or SPADs reduces the amount of laser pulse energy required for long-distance ranging to poorly reflective targets. The technological challenge of these photodetectors is that they must also be able to accommodate the incredibly large dynamic range of signal amplitudes.

As dictated by the properties of the optics, the focus of a laser return changes as a function of range; as a result, near objects are often out of focus. Furthermore, also as dictated by the properties of the optics, the location and size of the “blur”—i.e., the spatial extent of the optical signal-changes as a function of range, much like in a standard camera. These challenges are commonly addressed by using large detectors, segmented detectors, or multi-element detectors to capture all of the light or just a portion of the light over the full-distance range of objects. It is generally advisable to design the optics such that reflections from close objects are blurred, so that a portion of the optical energy does not reach the detector or is spread between multiple detectors. This design strategy reduces the dynamic range requirements of the detector and prevents the detector from damage.

Acquisition of the lidar imagery can include, for example, a 3D lidar system embedded in the front of car, where the 3D lidar system, includes a laser transmitter with any necessary optics, a single-element photoreceiver with any necessary dedicated or shared optics, and an optical scanner used to scan (“paint”) the laser over the scene. Generating a full-frame 3D lidar range image—where the field of view is 20 degrees by 60 degrees and the angular resolution is 0.1 degrees (10 samples per degree)—can require emitting 120,000 pulses (20*10*60*10 = 120,000). When update rates of 30 frames per second are required, such as is commonly required for automotive lidar, roughly 3.6 million pulses per second must be generated and their returns captured.

There are many ways to combine and configure the elements of the lidar system-including considerations for the laser pulse energy, beam divergence, detector array size and array format (e.g., single element, linear (1D) array, or 2D array), and scanner to obtain a 3D image. If higher power lasers are deployed, pixelated detector arrays can be used, in which case the divergence of the laser would be mapped to a wider field of view relative to that of the detector array, and the laser pulse energy would need to be increased to match the proportionally larger field of view. For example- compared to the 3D lidar described previously-to obtain same-resolution 3D lidar images 30 times per second, a 120,000-element detector array (e.g., 200 × 600 elements) could be used with a laser that has pulse energy that is 120,000 times greater. The advantage of this “flash lidar” system is that it does not require an optical scanner; the disadvantages are that the larger laser results in a larger, heavier system that consumes more power, and that it is possible that the required higher pulse energy of the laser will be capable of causing ocular damage. The maximum average laser power and maximum pulse energy are limited by the requirement for the system to be eye-safe.

As noted above, while many lidar system operate by recording only the laser time of flight and using that data to obtain the distance to the first target return (closest) target, some lidar systems are capable of capturing both the range and intensity of one or multiple target returns created from each laser pulse. For example, for a lidar system that is capable of recording multiple laser pulse returns, the system can detect and record the range and intensity of multiple returns from a single transmitted pulse. In such a multi-pulse lidar system, the range and intensity of a return pulse from a from a closer-by object can be recorded, as well as the range and intensity of later reflection(s) of that pulse-one(s) that moved past the closer-by object and later reflected off of more-distant object(s). Similarly, if glint from the sun reflecting from dust in the air or another laser pulse is detected and mistakenly recorded, a multi-pulse lidar system allows for the return from the actual targets in the field of view to still be obtained.

The amplitude of the pulse return is primarily dependent on the specular and diffuse reflectivity of the target, the size of the target, and the orientation of the target. Laser returns from close, highly-reflective objects, are many orders of magnitude greater in intensity than the intensity of returns from distant targets. Many lidar systems require highly sensitive photodetectors, for example avalanche photodiodes (APDs), which along with their CMOS amplification circuits. So that distant, poorly-reflective targets may be detected, the photoreceiver components are optimized for high conversion gain. Largely because of their high sensitivity, these detectors may be damaged by very intense laser pulse returns.

For example, if an automotive equipped with a front-end lidar system were to pull up behind another car at a stoplight, the reflection off of the license plate may be significant-perhaps 10^12 higher than the pulse returns from targets at the distance limits of the lidar system. When a bright laser pulse is incident on the photoreceiver, the large current flow through the photodetector can damage the detector, or the large currents from the photodetector can cause the voltage to exceed the rated limits of the CMOS electronic amplification circuits, causing damage. For this reason, it is generally advisable to design the optics such that the reflections from close objects are blurred, so that a portion of the optical energy does not reach the detector or is spread between multiple detectors. However, capturing the intensity of pulses over a larger dynamic range associated with laser ranging may be challenging because the signals are too large to capture directly. One can infer the intensity by using a recording of a bit-modulated output obtained using serial-bit encoding obtained from one or more voltage threshold levels. This technique is often referred to as time-over-threshold (TOT) recording or, when multiple-thresholds are used, multiple time-over-threshold (MTOT) recording.

For some 1D scanned lidar applications, such as automotive sensing, distant objects of interest (such as vehicles, pedestrians and/or stationary objects) may span a narrow fan of angles of elevation near the horizon. Additionally, distant objects return a much smaller portion of the transmitted laser energy than close objects, because the solid angle subtended by a lidar system’s receive aperture, as seen from the vantage point of an object’s surface, decreases as the reciprocal of the square of the distance between object and sensor. In contrast, close objects of interest may span a much broader fan of angles of elevation. For example, a person standing 200 m (660 ft) from an automobile-deployed lidar system would subtend only a small vertical angle relative to the FOV of the system’s detector, whereas if the person were standing close to the automobile (e.g., 1 m), the person would likely completely fill the detector’s FOV.

An aspect of the present disclosure is directed to lidar systems having transmit (transmission) or illumination optics that project more laser pulse energy per pixel instantaneous FOV (IFOV) to one or more portions of the related optical sensor’s FOV, e.g., a portion that would be expected to have both close and distant objects of interest, and proportionally less pulse energy per pixel IFOV to other portions of the sensor’s FOV, e.g., those that would be expected to have only close objects of interest. Exemplary embodiments include a diffractive optical element (DOE), a gradient-index (GRIN) lens, and/or a compound lens assembly, as a transmission/illumination optic or optics. The systems can improve lidar range performance by providing for more efficient use of the total available laser pulse energy than transmit optics that project uniform pulse energy per pixel IFOV across the sensor FOV. Thus, embodiments of the present disclosure can enable or provide use of mechanically simpler, physically more compact, higher-resolution, and computationally less demanding scanned lidar systems, e.g., with 1D arrays, while keeping the laser power required to see at longer ranges, e.g., 200+ meters, manageable.

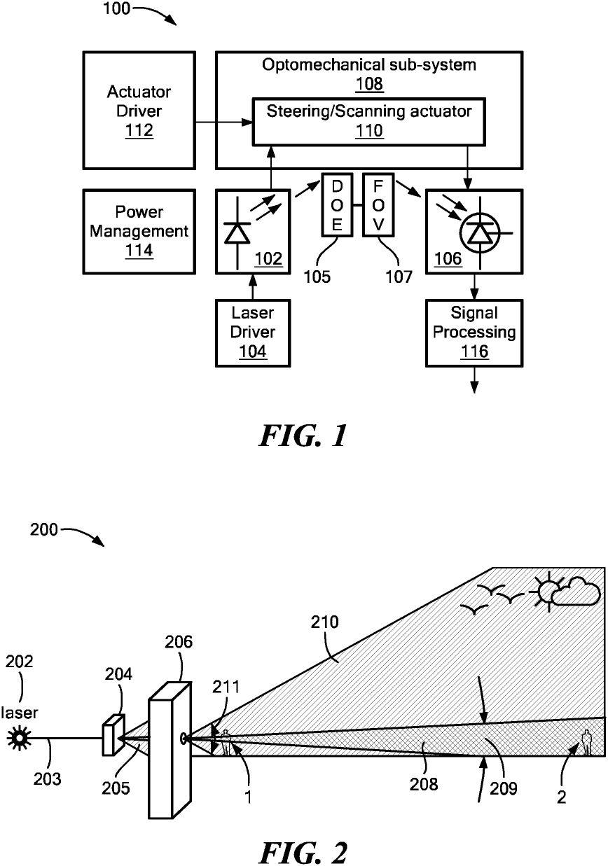

FIG. 1 is a block diagram showing major components of an example embodiment of a scanned lidar system 100, in accordance with the present disclosure. System 100 includes an illumination source 102, shown as laser diode, connected to laser driver 104, and an illumination optic or optics 105. The illumination source (laser) 102 produces an output (or, laser output). Optic 105 receives the laser output and produces a fan-beam output having a desired irradiance distribution with multiple parts or regions, as described in further detail below. In example embodiments, optic 105 can include, but is not limited to, a diffractive optical element (DOE), a gradient-index (GRIN) lens, and/or a compound lens system or assembly (which can include one or more mirrors or reflective surfaces in addition to lenses or refractive optical elements). In cross section, the fan-beam can have a generally oval or elliptical shape, e.g., of any desired eccentricity (including an eccentricity value of one). Appropriate pumping energy may be supplied by suitable sources, e.g., diodes lasers, for the case where laser 102 includes a non-semiconductor active medium such as a crystalline or glass material (host or matrix) doped with a rare earth element or elements. An optical receiver or detector 106, shown as a representative photodiode. The detector 106 can be or include an array of induvial detectors, e.g., a one-dimensional array (1 × N) or a two-dimensional array (M × N). A field of view (FOV) 107 of the detector is shown on the optical path between the laser (illumination source) 102 and the detector 106, which is directed to and “viewing” the FOV 107. Detector 106 operates to detect energy reflected from objects and/or surfaces in the FOV 107. An optomechanical subsystem 108, which typically includes an actuator for transmit beam steering 110, can be included to scan the illumination source 102 and receiver 106. An actuator driver 112 can control the movement of the actuator 110. Additional optics (not shown) can be used for either or both of the illumination side (with illumination source 102) and receive side (with receiver/detector 106) of system 100.

System 100 further includes a power management block 114, which provides and controls power to the system 100. Once received at the receiver 106, the incident photons are converted by the receiver (e.g., photodiodes) to electrical signals, which can be read-out by for signal processing, including amplification, discrimination, timing, digitization, and point cloud generation, as indicated by signal processing block 116.

FIG. 2 is a diagram of an exemplary system 200 utilizing a lidar illumination optic, in accordance with an embodiment of the present disclosure. System 200 includes a laser 202, operative to produce a laser output 203, and an illumination optic 204, that is configured to receive the laser output 203 and to produce a fan-beam output 205 having a desired irradiance (or, radiant flux) distribution over sections through the beam 205 taken normal to the beam’s axis of propagation. In example embodiments, the illumination optic 204 can be or include a diffractive optical element (DOE), a gradient-index (GRIN) lens, and/or a compound lens system or assembly, or the like. As shown, the fan-beam output 205 can include a first beam region 208 having an angular spread 209 in a first direction (e.g., vertical, or substantially vertical) and a second beam region 210 having an angular spread 211 in the first direction. In alternate embodiments, fan-beam output 209 can include more than two component beam regions.

The two component beam regions of fan-beam output 205 can be used or considered as a “far look” beam region 208 and “near look” beam region 210. The average irradiance within the first beam region 208 is higher than that of the second beam region 210, in exemplary embodiments. Such an irradiance distribution, with first beam region 208 configured for relatively longer (“far look”) distances, is indicated by its darker shading compared to that of second beam region 210. Fan-beam output 205 provides some irradiance distribution for illuminating and viewing objects closer to the system 200 while also providing a higher irradiance distribution for illuminating and viewing objects further away from the system 200. While the transition between the two beam regions 208, 210 is shown as abrupt, this is merely for ease of explanation, and the distribution may be gradual or graded, in some embodiments. A person is indicated at representative near and far locations 1, 2, respectively.

As shown, system 200 also includes a scanning system 206 for scanning the output the fan beam output in a desired direction, e.g., azimuth. Photodetectors (not shown) can be used to detect the returns from the distant objects/surfaces and a timing system (not shown) can be used to calculate distances (ranges) accordingly, forming a 3D landscape corresponding to the objects and surfaces in the FOV and the related field-of-regard (FOR) (the volume subtended by the scanned FOV).

In exemplary embodiments, the angular spread 209 of the first beam region 208 in the first direction (e.g., vertical) is between about 5 and about 15 degrees; in example embodiments, the angular spread of the first fan-beam in the first direction is about 6 degrees. In exemplary embodiments, the angular spread 211 of the second beam region 210 in the first direction (e.g., vertical) is between about 20 and about 50 degrees; in example embodiments the angular spread 211 in the first direction is about 30 degrees. Beam regions 208 and 210 may have the same, similar, or different angular spread in a second (e.g., horizontal direction) or other direction. The second direction may be orthogonal to the first direction; in exemplary embodiments, the angular spread in the second direction is selected to produce a fan-beam cross section (orthogonal to the beam axis) that is an elliptical stripe with the extent in the first direction forming the major axis and the extent in the second direction forming the minor axis. Moreover, in exemplary embodiments, the first beam region 208 is within (potentially but not necessarily centered) a solid angle defined by the second beam region 210. In example embodiments, the second beam region 210 includes or is made up of two beam regions (a.k.a. “wings”), each flanking the first beam region 208 on a respective side; such flanking beam regions can be but are not necessarily similar in shape and/or irradiance distribution.

Any suitable laser may be used for laser 202. For exemplary embodiments, the laser 202 can include an active medium including a crystal or glass matrix doped with rare earth ions. In some embodiments, laser 202 may include a diode-pumped solid-state laser having an active medium including erbium-doped glass. In exemplary embodiments, the laser active medium can include erbium-doped yttrium aluminum borate (YAB). In some embodiments, laser 202 or associated pumping diodes may utilize or include indium-gallium-arsenide (InGaAs) or other suitable semiconductor alloy(s) as an active medium. In exemplary embodiments, laser 202 produces an output in the near infrared (NIR) and/or short wavelength infrared (SWIR), e.g., any wavelength or range of wavelengths from about 730 nm to about 2100 nm and inclusive of any sub-range therein. In exemplary embodiments, the laser 202 can be operative to produce a laser output having a wavelength of between about 800 nm and about 1800 nm, e.g., between about 1500 nm and about 1600 nm, between about 1515 nm and 1560 nm, or other sub-ranges, and/or wavelengths of (about) of 850 nm, 865 nm, 905 nm, 940 nm, 1350 nm, 1534 nm, or 1550 nm as non-limiting examples; active media producing other wavelengths may of course be utilized within the scope of the present disclosure. In exemplary embodiments, laser 202 is a laser that is Class 1 eye-safe in accordance with industry-standard safety regulations, e.g., IEC 60825-1: 2014 and/or ANSI Z136.1-2014 (including as periodically updated).

As opposed to circular spots of typical lidar outputs, the fan-beam output 205 produced by optic 204 can be well-matched to the FOV of a linear sensory array such as used in scanning lidar systems. Embodiments of the present disclosure, e.g., system 200 depicted in FIG. 2, may be particularly well-suited to large format 1D lidar arrays that are used in lidar systems that scan across the azimuthal angle. In an exemplary embodiment, system 200 may be used in conjunction with a 1×512 element detector (sensor) array.

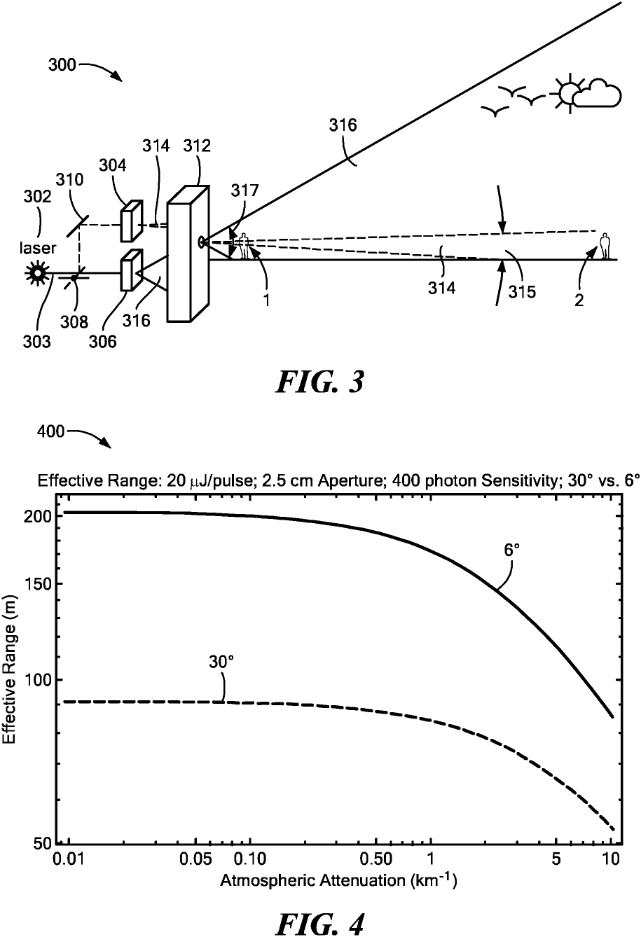

FIG. 3 is a diagram of a lidar illumination system 300 using first and second optics, in accordance with a further embodiment of the present disclosure. System 300 includes a laser 302, which is operative to produce a laser output 303 for lidar ranging/imaging, and first and second optics 304, 306 for illumination. In example embodiments, optics 304, 306 can include diffractive optical elements (“DOE”s), GRIN lenses, and/or compound lens systems or assemblies, or the like. An optical switch 308 selectively routes the laser output 303 to one of the optics 304 or 306. The optics 304, 306 are used to diffract and/or shape the laser output 303, each producing a fan-beam 314, 316 having different beam characteristics, including angular divergence and irradiance distribution (over sections through the respective beam taken normal to the beam’s axis of propagation). Any suitable laser may be sued for laser 302, e.g., as described above for system 200. While two optics (304, 306) are shown, more than two may be used in alternate embodiments, each producing a respective and potentially different fan beam. A person is indicated at representative near and far locations 1, 2, respectively.

Each of the optics 304, 306 (e.g., DOEs, GRIN lenses, and/or compound lens systems), produces a fan-beam with a different angular spread in a first (e.g., vertical) direction. As shown, first fan-beam 314 has a narrower angular spread 315 in the vertical dimension and is designed or configured for illumination at longer distances (a “look far” configuration). Second fan-beam 316 provides a wider angular spread 317 (vertically) and is designed for illumination at closer distances (a “look near” configuration). Switch 308 (e.g., a flip mirror or the like) allows for selective switching between the look-near and look-far fan-beams 314, 316 as desired. The look-far distribution of fan-beam 314 provides for illumination of a smaller solid angle than the look-close fan-beam 316. The relatively smaller solid angle of fan-beam 314 can correspond to a reduced portion of a FOV of a lidar sensor (not shown) used with the illumination system 300. The reduced portion of the sensor FOV would be, e.g., sufficient to scan ground surface at longer distances from the system 300. By using fan-beam 314, system 300 effectively increases the illumination power per pixel IFOV at the longer illumination distances compared to fan-beam 316, using the same pulse energy from laser output 303.

In exemplary embodiments, the angular spread 315 of the first fan-beam 314 in the first (e.g., vertical) direction is between about 5 and about 15 degrees; in example embodiments, the angular spread of the first fan-beam in the first direction is about 6 degrees. In exemplary embodiments, the angular spread 317 of the second fan-beam 316 in the first direction is between about 20 and about 50 degrees; in example embodiments the angular spread 317 in the first (e.g., vertical) direction is about 30 degrees. Fan-beams 314 and 316 may have the same, similar, or different angular spreads in a second direction (e.g., horizontal) direction (the second direction can be orthogonal to the first direction); in exemplary embodiments, the angular spread in the second direction is selected to produce a fan-beam cross section (orthogonal to the beam axis) that is an elliptical stripe, with the extent in the first direction forming the major axis and the extent in the second direction forming the minor axis. In exemplary embodiments, the first fan-beam 314 is within (potentially but not necessarily centered) a solid angle defined by the second fan-beam 316, as shown.

Because, for moving vehicles, closer objects are of more concern for collision-avoidance than are distant objects, the time the system 300 spends utilizing the wider-angle optic 306 with fan-beam 316, i.e., the time spent “looking close,” may be selected to be greater than the time the system spends utilizing the narrower-angle optic 304 with fan-beam 314, i.e., the time spent “looking far.” Of course, the relative proportion between the two “looks” can be selected as desired. In some situations, or applications, system 300 may accordingly spend more time using the narrower-angle optic 304.

As shown, system 300 can include a scanning system 312 for scanning the output (whichever fan-beam is selected) in a desired direction, for example, in azimuth. Photodetectors (not shown) operate to detect the returns from the distant objects/surfaces and a timing system is used to calculate distances (ranges) accordingly, forming a 3D landscape corresponding to the FOV and related field-of-regard (FOR) (the volume subtended by the scanned FOV). In some embodiments, the “look-close” and “look-far” measurement can be interleaved during the azimuthal angle sweep of a single lidar frame, rather than switching configurations between frames. In some embodiments, either optic 304, 306 may be configured to produce a fan-beam having a non-uniform energy distribution, e.g., like as described and shown for beam output 205 of FIG. 2.

FIG. 4 is a plot 400 showing a comparison of effective range for lidar pulse energy spread across two different angles of angular spread in the vertical direction, 6 degrees (6°) and 30 degrees (30°), in accordance with the present disclosure. The laser pulse characteristics are indicated as 20 µJ/pulse with an aperture of 2.5 cm. An associated detector used for collecting plotted data is indicated as having 400-photon sensitivity. Atmospheric attenuation per kilometer is shown with a log scale on the lower horizontal axis. Effective range in meters is shown on the vertical axis.

As shown, use of a fan-beam or beam region having an angular spread of 6 degrees (6°), for the given energy density, results in an effective maximum range of 200 m compared to the approximately 90 m range for the fan-beam or beam region of 30 degrees (30°) angular spread. The plot 400 further shows that the narrower-angle fan-beam or beam region maintains roughly 2:1 increase in effective range across the indicated atmospheric attenuation conditions. A comparison of a 6-degree and 30-degree angular spreads is shown in FIG. 2 by beam regions 208 and 210 at position 2.

FIG. 4 illustrates that, using 200 m as an example of a “far” distance for automotive lidar applications (where an angle of elevation of just 1° above the horizon equates to a height of about 3.5 meters at a range of about 200 meters), for a laser pulse with energy/irradiance that is fanned across ±3° centered on the horizon (6° total), the energy per pixel will be 5× higher than if distributed across the full 30° FOV that is typically needed to image close objects. That improvement (5x) in signal strength per illuminated pixel (iFOV) corresponds to more than twice the effective range for a conventional fixed laser pulse energy, receiver aperture, and pixel sensitivity.

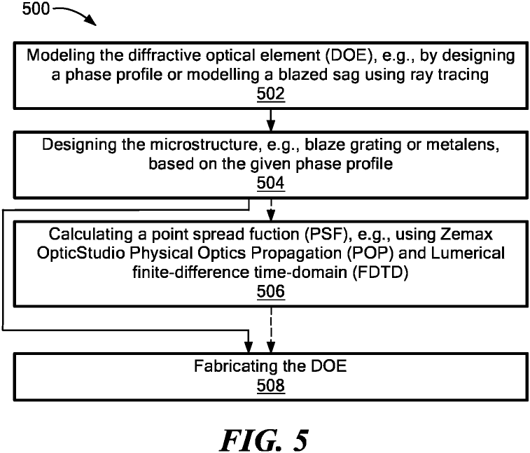

FIG. 5 is a block diagram depicting an example method 500 of designing a diffractive optical element (DOE) having a desired beam region orfan-beam profile and energy or irradiance distribution in accordance with embodiments of the present disclosure. For method 500, a DOE can be modeled, e.g., by designing a phase profile or modeling a blazed sag using ray tracing, as described at 502. The microstructure of the DOE can be designed, e.g., as a blaze grating or metalens, based on the given phase profile, as described at 504. As an optional step, a point spread function (PSF) of the microstructure can be calculated, e.g., using Zemax OpticStudio Physical Optics Propagation (POP) together with Lumerical finite-difference time-domain (FDTD) solver software, as described at 506. OpticStudio is commercially available from Zemax, Inc. Lumerical FDTD solver software is a simulator within Lumerical’s DEVICE Multiphysics Simulation Suite, and is capable of solving Maxwell’s equations for complex geometric shapes; other suitably equivalent FDTD software may be used. The DOE can then be fabricated, as described at 508, using known lithography and/or microfabrication methods (and optionally tested).

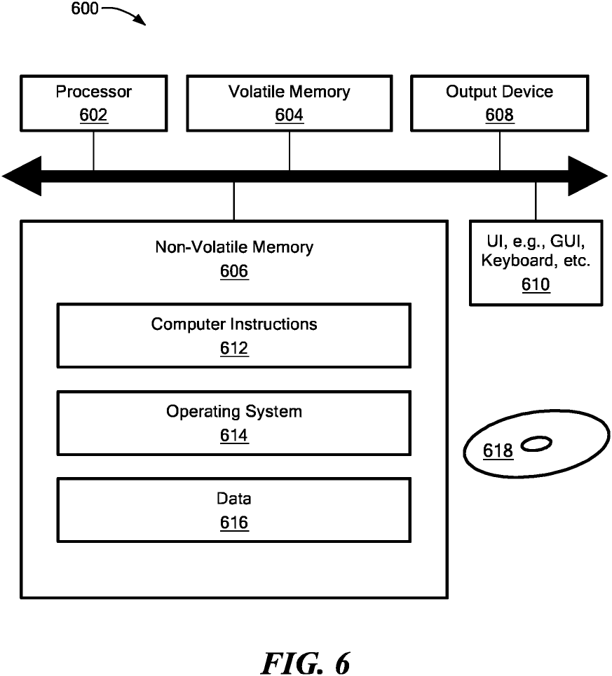

FIG. 6 is a schematic diagram of an example computer system 600 that can perform all or at least a portion of the processing, e.g., steps in the algorithms and methods, including design of DOEs, GRIN lenses, and/or compound lens systems or assemblies, described herein. The computer system 600 includes a processor 602, a volatile memory 604, a non-volatile memory 606 (e.g., hard disk), an output device 608 and a user input or interface (UI) 610, e.g., graphical user interface (GUI), a mouse, a keyboard, a display, and/or any common user interface, etc. The non-volatile memory (non-transitory storage medium) 606 stores computer instructions 612 (a.k.a., machine-readable instructions or computer-readable instructions) such as software (computer program product), an operating system 614 and data 616. In one example, the computer instructions 612 are executed by the processor 602 out of (from) volatile memory 604. In one embodiment, an article 618 (e.g., a storage device or medium such as a hard disk, an optical disc, magnetic storage tape, optical storage tape, flash drive, etc.) includes or stores the non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), and optionally at least one input device, and one or more output devices. Program code may be applied to data entered using an input device or input connection (e.g., port or bus) to perform processing and to generate output information.

The system 600 can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry, e.g., an FPGA (field programmable gate array) and/or an ASIC (application-specific integrated circuit).

Accordingly, embodiments of the inventive subject matter can afford various and numerous benefits relative to prior art techniques. For example, embodiments of the present disclosure can enable or provide use of mechanically simpler, physically more compact, higher-resolution, and computationally less demanding 1D scanned lidar systems while keeping the laser power required to see at longer ranges, e.g., 200 meters, manageable.

Various embodiments of the concepts, systems, devices, structures, and techniques sought to be protected are described above with reference to the related drawings. Alternative embodiments can be devised without departing from the scope of the concepts, systems, devices, structures, and techniques described. For example, while refence is made above to pulsed lasers, continuous wave (CW) lasers may be used within the scope of the present disclosure. Moreover, while embodiments are described as used with scanning lidar systems, illumination or transmit optics and techniques as described herein may be used with/for flash lidar systems within the scope of the present disclosure. Further, while embodiments are described herein as including first and second beam regions, fan-beams, and/or optics (e.g., DOEs, etc.), alternate embodiments can include, produce, or use more than two such beam regions, fan-beams, or optics (e.g., DOEs, etc.).

It is noted that various connections and positional relationships (e.g., over, below, adjacent, etc.) may be used to describe elements in the description and drawing. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising, “include,” “includes,” “including,” “has,” “having,” “contains” or “containing,” or any other variation are intended to cover a non-exclusive inclusion. For example, an apparatus, a method, a composition, a mixture, or an article that comprises a list of elements is not necessarily limited to only those elements but can include other elements not expressly listed or inherent to such apparatus, method, composition, mixture, or article.

Additionally, the term “exemplary” is means “serving as an example, instance, or illustration. Any embodiment or design described as “exemplary” is not necessarily to be construed as preferred or advantageous over other embodiments or designs. The terms “one or more” and “at least one” indicate any integer number greater than or equal to one, i.e., one, two, three, four, etc. The term “plurality” indicates any integer number greater than one. The term “connection” can include an indirect “connection” and a direct “connection”.

References in the specification to “embodiments,” “one embodiment, “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within plus or minus (±) 10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

What is claimed is:

1. An illumination system for scanned lidar, the system comprising:
a. a laser operative to produce a laser output;
b. an optic operative to receive the laser output and produce a fan-beam output having a desired irradiance distribution including (i) a first beam region having an angular spread in a first direction, and (ii) a second beam region having an angular spread in the first direction, wherein the angular spread of the first beam region in the first direction is less than that of the second beam region, wherein the average irradiance within the first beam region is higher than that of the second beam region, and wherein the first beam region is within a solid angle defined by the second beam region; and
c. a scanning system operative to scan the fan-beam output across a desired angular span in a direction substantially orthogonal to the first direction.

2. The system of claim 1, wherein the first beam region comprises an elliptical cross section.

3. The system of claim 1, wherein the second beam region comprises an elliptical cross section.

4. The system of claim 1, wherein the second beam region comprises two beam regions, each flanking the first beam region.

5. The system of claim 1, wherein the angular spread of the second beam region in the first direction is between about 20 and about 50 degrees.

6. The system of claim 5, wherein the angular spread of the second beam region in the first direction is about 30 degrees.

7. The system of claim 5, wherein the angular spread of the first beam region in the first direction is between about 5 and about 15 degrees.

8. The system of claim 7, wherein the angular spread of the first beam region in the first direction is about 6 degrees.

9. The system of claim 1, wherein the first direction is substantially normal to a ground surface.

10. The system of claim 9, wherein the scanning system is operative to scan the fan-beam substantially parallel to the ground surface, such that the angle scanned is an azimuthal angle.

11. The system of claim 1, wherein the laser includes an active medium comprising a crystal or glass matrix doped with rare earth ions.

12. The system of claim 1, wherein the laser is operative to produce a laser output having a wavelength of between about 800 nm and about 1800 nm.

13. The system of claim 12, wherein the laser output has a wavelength of between about 1500 nm and about 1600 nm.

14. The system of claim 12, wherein the laser output has a wavelength of about 905 nm.

15. The system of claim 13, wherein the laser output has a wavelength of between about 1515 nm and 1560 nm.

16. The system of claim 11, wherein the active medium comprises erbium-doped yttrium aluminum borate (YAB).

17. The system of claim 1, wherein the optic comprises a diffractive optical element (DOE).

18. The system of claim 1, wherein the optic comprises a gradient-index (GRIN) lens.

19. The system of claim 1, wherein the optic comprises a compound lens system.

20. An illumination system for scanned lidar, the system comprising:
a. a laser operative to produce a laser output;
b. a first optic operative to receive the laser output and produce a first fan-beam having a first angular spread in a first direction and a first desired irradiance distribution;
c. a second optic operative to receive the laser output and produce a second fan-beam having a second angular spread in the first direction and a second desired irradiance distribution, wherein the angular spread of the first fan-beam in the first direction is less than that of the second fan-beam, wherein the average irradiance within the first fan-beam is higher than that of the second fan-beam, and wherein the first fan-beam is within a solid angle defined by the second fan-beam;
d. a switch operative to direct the laser output to either the first optic or the second optic; and
e. a scanning system operative to scan the first fan-beam or the second fan-beam across a desired angular span in a direction substantially orthogonal to the first direction.

21. The system of claim 20, wherein the first fan-beam comprises an elliptical cross section.

22. The system of claim 20, wherein the second fan-beam comprises an elliptical cross section.

23. The system of claim 20, wherein the second fan-beam comprises two beam regions, each flanking the first fan-beam.

24. The system of claim 20, wherein the angular spread of the second fan-beam in the first direction is between about 20 and about 50 degrees.

25. The system of claim 24, wherein the angular spread of the second fan-beam in the first direction is about 30 degrees.

26. The system of claim 20, wherein the angular spread of the first fan-beam in the first direction is between about 5 and about 15 degrees.

27. The system of claim 26, wherein the angular spread of the first fan-beam in the first direction is about 6 degrees.

28. The system of claim 20, wherein the laser has an active medium comprising a crystal or glass matrix doped with rare earth ions.

29. The system of claim 20, wherein the laser is operative to produce a laser output having a wavelength of between about 800 nm and about 1800 nm.

30. The system of claim 29, wherein the laser output has a wavelength of between about 1500 nm and about 1600 nm.

31. The system of claim 29, wherein the laser output has a wavelength of about 905 nm.

32. The system of claim 30, wherein the laser output has a wavelength of between about 1515 nm and 1560 nm.

33. The system of claim 28, wherein the active medium comprises erbium-doped yttrium aluminum borate (YAB).

34. The system of claim 20, wherein the first direction is substantially normal to a ground surface.

35. The system of claim 34, wherein the scanning system is operative to scan the first fan-beam or the second fan-beam substantially parallel to the ground surface, such that the angle scanned is an azimuthal angle.

36. The system of claim 20, wherein the first and/or second optic comprises a diffractive optical element (DOE).

37. The system of claim 20, wherein the first and/or second optic comprises a gradient-index (GRIN) lens.

38. The system of claim 20, wherein the first and/or optic comprises a compound lens system.
